(19) United States
(12) Patent Application Publication
(10) Pub. No.: US 2004/0234419 A1
(43) Pub. Date: Nov. 25, 2004

(54) Assembly head comprising a stepped-drive rotating rotor and a pneumatic pressure control device

(76) Inventors: Stefan Burger, Munchen (DE); Rainer Dubel, Baldham (DE)

Correspondence Address: HARNESS, DICKEY & PIERCE, P.L.C., P.O.BOX 8910, RESTON, VA, 20195, US

(21) Appl. No.: 10/479,748

(22) PCT Filed: May 24, 2002
(86) PCT No.: PCT/DE02/01920

(30) Foreign Application Priority Data
Jun. 7, 2001 (DE) 101 27 735.0

(51) Int. Cl. B01L 3/02

(52) U.S. Cl. 422/100

(57) ABSTRACT

The assembly head (15) comprises a permanent retaining circuit for all pipettes (1) with a vacuum flow. In a placing or picking station the relevant pipette is additionally connected to a stationary regulator valve, the working pressure of which may be superimposed on the permanent vacuum to regulate between over- and under-pressure. The process reliability of the assembly head may thus be significantly improved.

This application is the national phase under 35 U.S.C. § 371 of PCT International Application No. PCT/DE02/01920 which has an International filing date of May 24, 2002, which designated the United States of America and which claims priority on German Patent Application number DE 101 27 735.0 filed Jun. 7, 2001, the entire contents of which are hereby incorporated herein by reference.

### FIELD OF THE INVENTION

The invention generally relates to an insertion head. Preferably, it relates to one with a stator moving in a linear guide and a stepwise rotatable rotor which has a plurality of pipettes for picking up electrical components. The pipettes may be connected to a pneumatic line, with one of the pipettes being moved to a placing or picking position and with the pipette located in this position being pressurized by a compressed air pulse via a regulator valve and connected by a circular slide to a stationary line.

### BACKGROUND OF THE INVENTION

It is known from DP 0 879 550 B1 that the regulator valve may be designed as a mechanically actuated changeover valve through which the pipette can be connected either to a vacuum or to compressed air as required. In this case it is normal to store threshold values of the vacuum for the different pipette types in order to be able to detect the presence or absence of a component. Pipettes for very small components have correspondingly small suction openings, with the pressure difference between the open and closed suction channel being very small. Even slight changes in the ambient pressure or the suction cross-section due to dirt lead to detection errors, resulting in faulty operation of the insertion device.

### SUMMARY OF THE INVENTION

An object of an embodiment of the invention may be to increase the operating reliability of the insertion device.

This object is achieved by an embodiment of the invention. As a result of the overlay control it is now no longer necessary to switch off the vacuum, so that the individual wear-susceptible valves can be dispensed with. All that is needed for this is to make sure that the channels leading to the valve are sealed outside the placing position by the slide valve and are connected to the regulator valve only in the placing position. By way of the line geometry in the area of the branch and by control of the pressure pulse it can be ensured that this does not affect the pressure conditions in the other pipettes.

The regulator valve isolated from the other pipettes by the slide valve can generate a vacuum of sufficient force so that maximum suction pressure is securely achieved when picking the component, regardless of whether the vacuum in the other pipettes fluctuates between a higher and lower level with full or low component loading.

The selector valve may represent a simple component that can be used particularly for handling uncritical components.

The regulator valve may enable the pressures in the control line to be set precisely to the most effective values in each case.

By way of the regulator valve, the control circuit within the regulator valve may be formed with a suitable short control cycle. The sensor and regulator valve form an integrated unit with defined line relationships and suitable accuracy in the event of the omission of an additional sensor.

The jet pump may be a simple, compact component that can be quickly and accurately regulated, with it being possible to adjust the actuating element acting as a backpressure restrictor particularly rapidly and accurately to the set control position by means of the controlled drive, e.g. with the aid of a path measuring device.

By way of a further development, the vacuum permanently present at each of the pipettes may be generated easily without the vacuum being switched off and is modified or overcompensated in a very short changeover time in order to be able to generate a compressed air pulse within a very narrow time frame at the moment of placement. However, it is also possible to connect the suction lines of the individual pipettes to a powerful central vacuum line.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

FIG. 1 shows a schematic of a known insertion head,

FIG. 2 is a similar but enlarged view of an insertion head according to an embodiment of the invention.

### DETAILED DESCRIPTION OF THE PREFERRED EMBODIMENTS

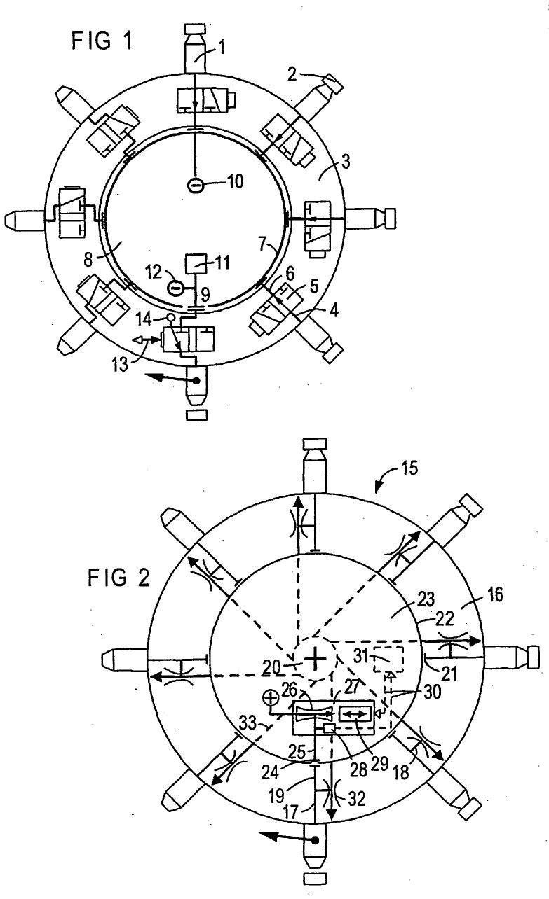

FIG. 1 shows a revolver-type insertion head with radially projecting pipettes 1 for picking components 2. The pipettes are mounted on a rotor 3 and each is connected to a pneumatic line 4 that terminates in a changeover valve 5. Suction lines 6 lead from this to a rotary slide valve-type distributor 7.

The rotor 3 can rotate in steps in the direction shown by the rotation arrow such that one of the pipettes 1 in each case is brought to a placing position in which the component 2 can be mounted on a printed circuit board or removed from a component store. The distributor 7 is located at the interface between the rotor 3 and a stator 8 and is arranged such that the particular suction line 6 in the placing position is temporarily connected to a stationary control line 9. The remaining suction lines 6 are connected to a permanent vacuum source of the stator 8. A pressure sensor 11, by which the pressure in the suction lines 6 can be monitored, is connected to the control line 9.

The control line 9 terminates in a selector valve 12 through which it can be switched to another vacuum source 10. The changeover valves 5 are actuated by a stationary mechanical drive 13 and remain in the selected setting during further rotation. Before the placement of the components 2, the changeover valves are at through flow, so that the pipettes 1 are connected to permanent vacuums. The selector valve 12 is also connected to a vacuum during the setting phase, so that the associated pipette 1 is supplied with a vacuum.

The changeover valve 5 located in the placing position is also temporarily connected to the compressed air source 14. After placing the component 2 on the printed circuit board, the mechanical drive 13 switches the changeover valve 5 to the compressed air source 14, from which a short compressed air pulse is output that reliably separates the component 13 from the pipette tip. The changeover valve 5 thus remains in this selected position, in which the pipette vents and the vacuum is switched off.

When the components 2 are picked, the drive 13 switches the changeover valve 5 to a different position, in which the pneumatic line 4 is connected with the control line 9 connected to the vacuum. This causes the component 2 to be picked. Because the changeover valve remains in this position when rotated further in the retaining circuit of the vacuum supply, the pipette also continues to remain under vacuum.

After the component 2 has been picked by the pipette 1 located in the mounting position, the vacuum in the control line 9 increases beyond a preset threshold value. This process is detected by the pressure sensor 11 and interpreted as correct. If on the other hand the vacuum threshold is not exceeded, an evaluation device detects the component as not correctly picked. Because the suction openings of the pipettes 1 are matched to different size components, the result, particularly with smaller components, is slight pressure differences which can be overlaid by the effect of environmental influences, so that a reliable evaluation is not possible. If a component cannot be picked or is subsequently lost, this leak can reduce the vacuum power of the vacuum source 10.

FIG. 2 shows a modified insertion head 15 according to an embodiment of the invention that is also fitted with pipettes 1 radially projecting from a rotor 16. The pipettes 1 are each connected to a pneumatic line 17 that branches into a suction line 18 and a control line 19. All the suction lines 18 are each connected to a jet pump 32 secured to the rotor and rotating with it, said pump being permanently and directly connected via a connecting line to a central pressure line 20 of the rotor 16 and generating a permanent vacuum in the suction line.

The control lines 19 each terminate in an opening 21 of the rotor 16 that is closed by a circular slide valve 22 of a stator 23. At the bottom placing positing of the pipettes 1, this has a slide valve opening 24 complementary to opening 21 that is connected by a stationary control line 25 to an internal jet pump 26 designed as a Venturi nozzle of a control valve 27 of the stator 23. The regulator valve 27 has a sensor 28 connected to the stationary line 25 for monitoring the working pressure in the control line 25 or 19.

The outlet opening of the jet pump 26 can be changed by a mechanically driven actuating element 29 in such a way that the pressure in the stationary control line 25 can be changed in fine stages. The sensor 28 and the mechanical drive are connected by electrical lines 30 to an electronic controller 31 in which the pressure values assigned to the different pipette types and/or component types are stored.

When the component 2 is placed on a circuit board, the working pressure in the control line 19 can be increased so much that it overlays the vacuum of the suction line 18 in the pneumatic line 17, so that a compressed air pulse controlled with regard to power and duration can be output to the component in order to separate this reliably from the pipette 1 and place it on the printed circuit board. When a component 2 is picked from a feed device, the suction pressure in the pneumatic line 17 can be monitored by way of the sensor 28.

The branch geometry between the suction line 18 and the control line 19 can be designed so as to be largely neutralizing, with the result that the vacuum in the suction line 18 barely influences the conditions in the control line 19 and the short pressure pulse of the control line 19 is only slightly coupled into the suction line 18.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An insertion head, adapted to move in a linear guide, comprising:
a stator; and
a stepwise rotatable rotor, including a plurality of pipettes for picking electrical components, wherein the pipettes are connected to a pneumatic line and wherein at least one
pipette is movable to at least one of a placing and picking position and wherein
the pipette located in this position is adapted to be pressurized via a control valve by a compressed air pulse and connected by a circular slide valve to a stationary line, wherein t
the pneumatic line branches into a suction line with a permanent vacuum flow and into a control line, connected by the stationary line to the control valve fixed to the stator, and wherein a pressure pulse output from the control valve is adapted to be adjusted and fed into the pneumatic line in such a way that it overlays the permanently present vacuum.

2. Insertion head according to claim 1, wherein the control valve designed as a selector valve is connected to its own pressure source and its own vacuum source.

3. Insertion head according to claim 1, wherein the control valve is designed as a regulator valve by which the working pressure is adapted to be regulated in fine stages.

4. Insertion head according to claim 3, wherein both overpressure and the underpressure in the control line are controllable.

5. Insertion head according to claim 1, wherein
the regulator valve includes an integral sensor for measuring the working pressure and wherein
the sensor is adapted to be activated in order to monitor the pneumatic line when picking and placing the component.

6. Insertion head according to claim 3, wherein
the regulator valve includes a jet pump with a main flow channel terminating in an outlet flow opening and a secondary flow channel branching therefrom,
wherein the outlet flow cross-section is changeable by an infinitely variable actuating element wherein and the actuating element is connected to a controllable mechanical drive.

7. Insertion head according to claim 6, wherein the drive includes a path measuring device.

8. Insertion head according to claim 1, wherein
each of the suction lines is connected to its own jet pump arranged on the rotor, each said pump being fed via a connecting line from a central pressure line of the rotor.

9. Insertion head according to claim 2, wherein the control valve is designed as a regulator valve by which the working pressure is adapted to be regulated in fine stages.

10. Insertion head according to claim 1, wherein the control valve is designed as a regulator valve by which overpressure in the control line is adapted to be regulated in fine stages.

11. Insertion head according to claim 2, wherein the control valve is designed as a regulator valve by which overpressure in the control line is adapted to be regulated in fine stages.

12. Insertion head according to claim 10, wherein both the overpressure and the underpressure in the control line are controllable.

13. Insertion head according to claim 11, wherein both overpressure and the underpressure in the control line are controllable.

14. Insertion head according to claim 4, wherein the regulator valve includes a jet pump with a main flow channel terminating in an outlet flow opening and a secondary flow channel branching therefrom, wherein the outlet flow cross-section is changeable by an infinitely variable actuating element wherein and the actuating element is connected to a controllable mechanical drive.

15. Insertion head according to claim 14, wherein the drive includes a path measuring device.

16. Insertion head according to claim 5, wherein the regulator valve includes a jet pump with a main flow channel terminating in an outlet flow opening and a secondary flow channel branching therefrom, wherein the outlet flow cross-section is changeable by an infinitely variable actuating element wherein and the actuating element is connected to a controllable mechanical drive.

17. Insertion head according to claim 16, wherein the drive includes a path measuring device.

18. An insertion head, adapted to move in a linear guide, comprising:
a stator;
a rotatable rotor, including a plurality of devices adapted to contact electrical components; and
means for pressurizing at least one pipette, in a component contacting position, by adjusting and feeding an output pressure pulse in such a way as to overlay a permanently present vacuum.

19. Insertion head according to claim 18, wherein both overpressure and the underpressure are controllable.
